(19) United States
(12) Patent Application Publication
(10) Pub. No.: US 2013/0085945 A1
(43) Pub. Date: Apr. 4, 2013

(54) Limited Access to a Digital Version of a Purchased Paper Book

(71) Applicant: Nathan J. Schultz, Cupertino, CA (US)

(72) Inventor: Nathan J. Schultz, Cupertino, CA (US)

(73) Assignee: CHEGG, INC., Santa Clara, CA (US)

(21) Appl. No.: 13/252,858

(22) Filed: Oct. 4, 2011

(51) Int. Cl. G06Q 30/00

(52) U.S. Cl. 705/307; 705/1.1

(57) ABSTRACT

A content distribution system provides instant partial and/or time-limited access to a web-accessible digital version of a purchased or rented paper book in connection with the sale of that book to the user. Access to a digital version of a purchased or rented paper book may be partial, thereby limited to a predetermined amount of content of the book. The portion(s) of the book to which access is granted is user-selectable, and can be located anywhere in the book. Access to a digital version of a purchased or rented paper book may be time-limited, thereby limited to a number of days or tied to shipping information such that the temporary access expires when the paper copy of the book is delivered to the purchaser.

BACKGROUND

1. Field of the Invention

This invention relates generally to web-based distribution of content.

2. Description of the Related Art

Online-based textbook rentals have proliferated in response to the high cost of paper-based textbooks. One challenge in online-based textbook rental is the lag time between placing an order for the paper book and receiving the shipment. This difficulty is compounded for students who change classes at the beginning of a school term and may not have a settled class schedule until a week or more after the school term has started. By the time a student orders a textbook for a class and waits for the shipment to arrive, the student may be substantially behind in the assigned reading.

Digital distribution methods for books can address some of these issues, but they raise different challenges. Digital distribution can be instantaneous, and need not require a physical shipping process. However, digital content may be inconvenient for note-taking and requires the student to access a computer or e-reader to view the content. Additionally, digital distribution poses an increased risk for both publishers and distributors. Without adequate protection, digital content can be copied and distributed outside of approved channels, which results in lost revenue for publishers and distributors.

### SUMMARY

In various embodiments, a content distribution system provides instant partial and/or time-limited access to a digital version of a purchased or rented paper book in connection with the sale of that book to the user. The digital version of the book can be accessed via a web-enabled device.

In one implementation, the access to a digital version of a purchased or rented paper book is partial, thereby limited to a predetermined amount of content of the book, such as a percentage of total words, or a particular predetermined number or percentage of chapters, pages, or the like. The portion(s) of the book to which access is granted is user-selectable, and can be located anywhere in the book. This allows students in classes that start the assigned reading, for example, at chapter 21, to access the relevant assigned portion of the digital version of a purchased or rented paper book while they wait for the paper version of the book to arrive.

In another implementation, the access to a digital version of a purchased or rented paper book may be temporary. For example, the temporary access may be time-limited to a number of days. As another example, the temporary access may be tied to shipping information such that the temporary access expires when the paper copy of the book is delivered to the purchaser. In some cases, the student has temporary access to the entire digital version of the book, and in other cases, the temporary access is only to a portion of the book, as described above.

The features and advantages described in this summary and the following detailed description are not all-inclusive. Many additional features and advantages will be apparent to one of ordinary skill in the art in view of the drawings, specification, and claims hereof.

### BRIEF DESCRIPTION OF THE DRAWINGS

FIG. 1 is a high-level block diagram of a system environment in accordance with an embodiment of the invention.

FIG. 2 illustrates a content distribution system, in accordance with an embodiment of the invention.

FIG. 3 is an interaction diagram illustrating a method of providing a user access to a web-based version of a purchased book, in accordance with an embodiment.

FIG. 4 is a flow chart illustrating a method of providing instant partial and/or time-limited access to a digital version of a purchased or rented paper book in connection with the sale of that book to the user, in accordance with an embodiment.

One skilled in the art will readily recognize from the following discussion that alternative embodiments of the structures and methods illustrated herein may be employed without departing from the principles of the invention described herein.

### DETAILED DESCRIPTION OF THE EMBODIMENTS

### System Overview

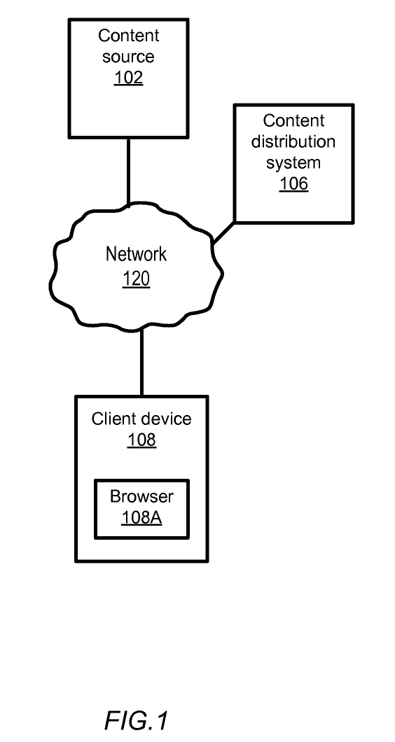

Illustrated in FIG. 1 is a high-level block diagram of a system environment in accordance with an embodiment of the invention. The system environment facilitates a content distribution system 106 that provides instant partial and/or time-limited access to a digital version of a purchased or rented paper book in connection with the transaction to sell or rent the paper book to the user. The system environment includes one or more content sources 102, a content distribution system 106, and one or more client devices 108. These components are connected by a network 120. Note that, for the sake of clarity, FIG. 1 depicts only one instance of content source 102 and client device 108, though there could be any number of additional instances each.

The content sources 102 provide books in digital or hardcopy format to the content distribution system 106. As used herein, the term “book” refers to any published content containing text and/or images, including but not limited to print books, magazines, newspapers, textbooks, course readers, and articles. The content sources 102 include but are not limited to the authors, editors, or publishers of the books.

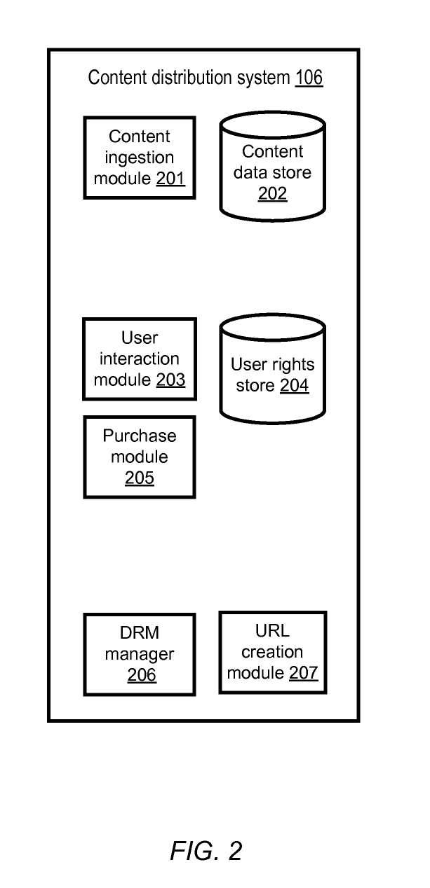

The content distribution system 106 provides instant partial and/or time-limited access to a digital version of a purchased paper book in connection with the sale of that book to the user. As used here, the terms “purchase” and “sale” refer to rental transactions as well as traditional sales transactions. The content distribution system 106 interacts with and exchanges data between the content sources 102 and the client devices 108 over the network 120. The content distribution system 106 is described in more detail below with respect to FIG. 2.

A client device 108 is a computing device that executes client software, e.g., a web browser 108A or built-in client application, to connect to the content distribution system 106 via a network 120 and to display digital content. The client device 108 might be, for example, a personal computer such as a desktop, laptop or tablet computer, a personal digital assistant, a mobile or smart phone, or a television “set-top box.” In some embodiments, the client 108 includes an embedded content viewer such as, for example, the ACROBAT reader from Adobe Systems, Inc. or any other viewer.

The network 120 facilitates communication between the various components of the system environment. The network 120 is typically the Internet, but may be any network, including but not limited to a LAN, a MAN, a WAN, a mobile wired or wireless network, a private network, or a virtual private network.

FIG. 2 illustrates one embodiment of the content distribution system 106 of FIG. 1. The content distribution system 106 includes a content ingestion module 201, a content data store 202, a user interaction module 203, a user rights store 204, a purchase module 205, a DRM manager 206 and a URL creation module 207.

The content ingest module 201 provides the content distribution system with a means of adding to the collection of books available in digital format. When the content distribution system 106 adds a new book available for sale, the content ingest module 201 creates a digital version of the book, for example, from a paper version of the book received from the content source 102. The content ingest module 201 stores the digital version of the book in the content data store 202. Subsequently, the digital versions of the books in the content data store 202 can be accessed by client devices 108 through the content distribution system 106.

The user interaction module 203 provides the content distribution system 106 with a means to communicate with the client device 108. The user interaction module 203 provides the client device 108 with a user interface (UI) to access the content distribution system 106, and receives input from that UI. For example, the user may purchase books from the content distribution system 106 using the UI.

The user rights store 204 stores information specific to the users of the content distribution system 106. In one embodiment, the user interaction module 203 provides the user rights store 222 with a username and password. The user rights store 204 may store the user's billing information, such as a bank account number, credit card number, billing address, BITCOIN wallet, or PAYPAL account. The user rights store 204 may also store information related to the purchases made by each user, and the digital access rights available to each user as a result of those purchases, including any restrictions on those access rights.

The purchase module 205 provides the content distribution system 106 with a means to transact purchases. The purchase module 205 receives requests for purchases from the user interaction module 203, may obtain payment information for purchases from users, and provides confirmation of a successful purchase to the user interaction module 203.

The DRM manager 206 enforces rules for accessing digital copies of books to ensure compliance with the contract terms of a respective licensing agreement governing the permissible access to the digital copy of a book. The DRM manager 206 monitors and enforces a user's partial and/or time-limited access to a digital version of a purchased paper book in connection with the sale of that book to the user. Partial access restrictions may include limiting access to a specific portion of the book, for example a specific number or percentage of pages, sections, or chapters. In one implementation, the specific portion of the book is user selectable. If the license specifies that a user is only authorized to access a certain number of pages of a digital book, the DRM manager 206 may maintain a record of the user's page views and prevent the user from gaining access to more than the authorized number of pages. Time-limited access may include limiting access to the book to a certain period of time, or where access to the book expires after some period of time. For example, if the license provides a time-limited 30 day window for a user to access a digital copy of a book, the DRM manager 206 may prevent access to the digital copy of the book by the user after 30 days. As another example, the time period may be tied to shipping information such that the time-limited access expires after the shipping information indicates the paper book was delivered to the user.

The URL creation module 207 provides the content distribution system 106 with a means to generate a unique URL for each user who has purchased a paper copy of a book to access pages from a digital version of the book. Responsive to a user completing a purchase of a book through the content distribution system 106, the URL creation module 207 creates a unique URL for the user to access a digital version of the book. The user interaction module 203 may receive the unique URL from the URL creation module 207 in order to communicate it to the user's client device 108. The DRM manager 206 can monitor a user's access to the URL and record the number or percentage of pages or chapters viewed, and may store this information in the user rights store 204.

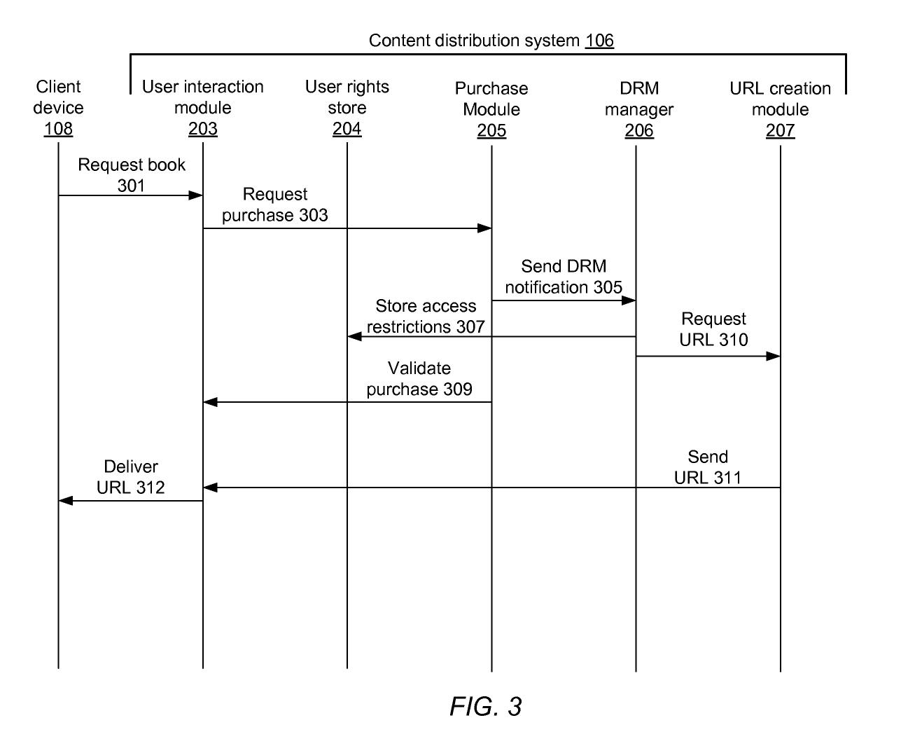

FIG. 3 illustrates an interaction diagram of one embodiment of a method of providing a user access to a digital version of a purchased book in connection with the purchase of the paper version of the book. The method includes receiving a request to purchase a book, notifying the DRM manager 206 of the purchase, and generating a URL for the user to access a digital version of the book.

First, the user of the client device 108 identifies a book for purchase and requests 301 the book. This request may come from, for example, a link in a product gallery, or a redirect from a third-party partner website or school course website. The book is identified with a book identifier, such as a Standard Book Number (SBN), an International SBN (ISBN), an Online Computer Library Center (OCLC) number, or a Library of Congress Control Number (LCCN), or any generic product identifiers, manufacturer's serial number, reseller product code, or any such number, code, or identifier. The client device 108 may also send billing information to the user interaction module 203 in order to purchase the book. In some cases, the limited access to a digital version of the purchased book may be offered at no additional charge as part of the purchase of the paper copy of the book. In other cases, an

In response to the user's request for a book 301, the user interaction module 203 routes a purchase request 303 for the book identified by an identifier described above to the purchase module 205 of the content distribution system 106. If any billing information was also collected from the user, this information is also sent to the purchase module 205. If no billing information was collected, the user interface module 203 may first obtain previously collected billing information from the user rights store 204 or elsewhere from the content distribution system 106, and provide this information to the purchase module 205. The purchase module 205 processes the transaction and completes the purchase for the identified book by deducting or charging the purchase amount from the account specified by the billing information. The purchase module 205 may queue the transaction for order fulfillment and shipping of the purchased paper book.

The purchase module 205 then sends a DRM notification 305 to the DRM manager 206. The DRM manager 206 obtains the rules applicable to limiting the access of the user to a digital version of the purchased paper book, for example from a local or remote storage (not shown) of contract provisions governing such access. The DRM manager 206 can store the purchase information and the access restrictions 307 in association with a user identifier, such as a username, in the user rights store 204. In one embodiment, the DRM manager 206 also requests a URL 310 from the URL creation module 207 of the content distribution system 106. In response to this request 310, the URL creation module 207 creates a unique URL for the user. This unique URL provides the user with a way of accessing the digital copy of the recently purchased book from any client device 108. In various embodiments, the URL may encode the access restrictions for the digital version of the book. For example, the URL may be generated based on information including the book identifier, the user identifier, whether the book is rented or sold, a time period, and/or other data. The URL creation module 207 sends 311 the URL to the user interaction module 203 for delivery 312 to the client device 108. The user interaction module 203 may deliver the URL to the client device 108 via email, via a web notification, or through any other messaging means. In various embodiments, the user interaction module 203 may deliver the URL to the client device 108 simultaneously with a purchase confirmation or in a subsequent communication. Thus, the user can quickly and easily access the URL to begin reading the book while waiting for the hardcopy book to be shipped to the user.

In various embodiments, the purchase module 205 sends validation of the purchase 309 to the user interaction module 203, for example, by sending a confirmation of purchase to the user interaction module 203. In various implementations, validation of the purchase 309 can be sent either before or after the purchase module 205 sends a DRM notification 305 to the DRM manager 206. After receiving the validation from the purchase module 205, the user interaction module 203 optionally may display a notice for the user confirming the purchase. The notice may further contain information regarding the estimated shipping date, and as mentioned above, may include the URL to enable to user to access the digital version and begin reading the book while waiting for the hardcopy book to be shipped.

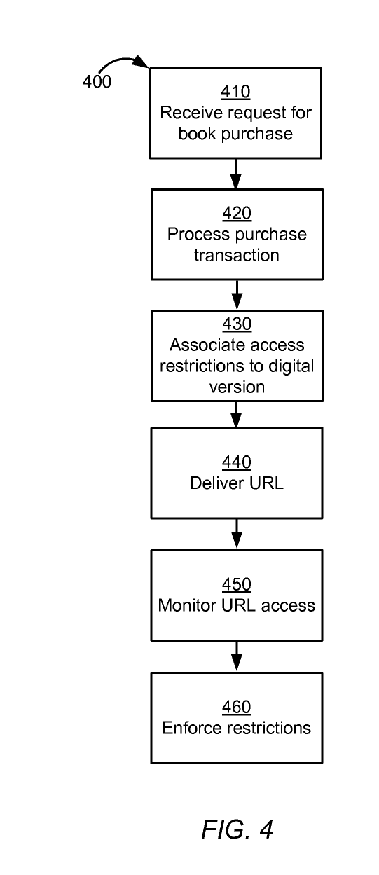

FIG. 4 illustrates a flowchart for an example method 400 for providing instant partial and/or time-limited access to a digital version of a purchased paper book in connection with the sale of that book to the user.

First, a request for a book purchase is received 410. For example, the content distribution system 106 may receive a request for a book purchase through a user interaction module 203, as described above with reference to FIG. 3.

Next, the purchase transaction for the book is processed 420. For example, the content distribution system 106 may process the book purchase as described above with reference to FIG. 3.

In connection with the purchase of the paper version of the book, the user is offered limited access to a digital version of the purchased book. Accordingly, access restrictions to the digital version of the purchased book are associated 430 with the user, for example, by the DRM manager 206, as described above with reference to FIG. 3.

To enable the user to access the digital version of the purchased book, a URL is delivered 440 to the user. For example, this may comprise first creating a URL and then sending it to the client device 108 as described above with reference to FIG. 3.

Next, access to the URL is monitored 450. For example, the DRM manager 206 of the content distribution system 106 monitors 450 the user's access of the URL. When the user accesses the URL, the DRM manager 206 identifies the accessed pages and/or the time of access. In various embodiments, when the user accesses pages or sections of the digital version of the book, the DRM manager 206 records these pages or sections to identify the user-selected portions of the book. In various embodiments, advertisements for products and/or services are displayed while the user is accessing the URL. In various embodiments, the tracking status of the previously purchased paper book is displayed while the user is accessing the URL.

Lastly, the access restrictions for the digital version of the purchased book are enforced 460. For example, the DRM manager 206 ensures that the access to the digital book is in compliance with the access restrictions relevant to the digital copy of the purchased book according to the respective license terms. If the partial access to the book is user-selectable, enforcing the access restrictions involves limiting the number of user-selectable pages or sections to the predetermined number, percentage, or portion. In various embodiments, the access history of the user is tracked by the DRM manager 206. If the user is determined to be in compliance with the access restrictions, then the user is allowed access to the digital book. If the user is determined to not be in compliance with the access restrictions, the user may be presented with a message that indicates the non-compliance and invites the user to purchase additional access rights to the digital book.

Accordingly, the content distribution system described with reference to FIGS. 1-4 allows instant partial and/or time-limited access to a digital version of a purchased paper book in connection with the sale of that book to the user. From the user's perspective, this system conveniently enables users to start reading a book as soon as they purchase it rather than waiting until the paper version is shipped to them. At the same time, from the publisher's perspective, this system protects the publisher's revenue stream by limiting the access to the digital book that is available to a user.

### Additional Configuration Considerations

The present invention has been described in particular detail with respect to several possible embodiments. Those of skill in the art will appreciate that the invention may be practiced in other embodiments. The particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of above description present the features of the present invention in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “determining” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may comprise a general-purpose computer selectively activated or reconfigured by a computer program stored on a computer readable medium that can be accessed by the computer and run by a computer processor. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

In addition, the present invention is not limited to any particular programming language. It is appreciated that a variety of programming languages may be used to implement the teachings of the present invention as described herein, and any references to specific languages are provided for enablement and best mode of the present invention.

The present invention is well suited to a wide variety of computer network systems over numerous topologies. Within this field, the configuration and management of large networks comprise storage devices and computers that are communicatively coupled to dissimilar computers and storage devices over a network, such as the Internet.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention.

1. A method for limiting access to a digital version of a purchased paper book, the method comprising:
processing a purchase transaction of a paper version of a book, the purchase transaction associated with a user;
associating access restrictions to a digital version of the purchased book, the access restrictions allowing the user to access a limited portion of the digital version of the purchased book, where the accessible limited portion of the digital version of the purchased book is selectable by the user;
receiving from the user a request to access a specified portion of the digital version of the purchased book;
applying, by a computer processor, the access restrictions to the user's request to access a specified portion of the digital version of the purchased book; and
subject to the access restrictions, delivering a URL to a device associated with the user, the URL for accessing the specified portion of the digital version of the purchased book.

2. The method of claim 1, wherein the purchase transaction comprises a rental of the paper version of the book.

3. The method of claim 1, further comprising:
monitoring access to the digital version of the purchased book, wherein the monitoring comprises identifying one or more sections of the digital version of the purchased book viewed during access.

4. The method of claim 1, wherein the URL for accessing the digital version of the purchased book is unique to a user.

5. The method of claim 1, wherein the access restrictions comprise a maximum portion of the book, and wherein enforcing the access restrictions comprises preventing access to a portion of the book in excess of the maximum portion of the book.

6. The method of claim 1, wherein the access restrictions comprise a maximum number of pages, and wherein enforcing the access restrictions comprises preventing access to pages in excess of the maximum number of pages.

7. The method of claim 1, wherein the access restrictions comprise a limited time period, and wherein enforcing the access restrictions comprises preventing access outside of the limited time period.

8. The method of claim 7, wherein the limited time period is tied to shipping of the paper version of the purchased book.

9. A computer-readable storage medium storing executable computer program instructions for limiting access to a digital version of a purchased paper book, the computer program instructions comprising instructions for:
processing a purchase transaction of a paper version of a book, the purchase transaction associated with a user;
associating access restrictions to a digital version of the purchased book, the access restrictions allowing the user to access a limited portion of the digital version of the purchased book, where the accessible limited portion of the digital version of the purchased book is selectable by the user;
receiving from the user a request to access a specified portion of the digital version of the purchased book;
applying, by a computer processor, the access restrictions to the user's request to access a specified portion of the digital version of the purchased book; and
subject to the access restrictions, delivering a URL to a device associated with the user, the URL for accessing the specified portion of the digital version of the purchased book.

10. The computer-readable medium of claim 9, wherein the purchase transaction comprises a rental of the paper version of the book.

11. The computer-readable medium of claim 9, further comprising instructions for:
monitoring access to the digital version of the purchased book, wherein the monitoring comprises identifying one or more sections of the digital version of the purchased book viewed during access.

12. The computer-readable medium of claim 9, wherein the URL for accessing the digital version of the purchased book is unique to a user.

13. The computer-readable medium of claim 9, wherein the access restrictions comprise a maximum portion of the book, and wherein enforcing the access restrictions comprises preventing access to a portion of the book in excess of the maximum portion of the book.

14. The computer-readable medium of claim 9, wherein the access restrictions comprise a maximum number of pages, and wherein enforcing the access restrictions comprises preventing access to pages in excess of the maximum number of pages.

15. The computer-readable medium of claim 9, wherein the access restrictions comprise a limited time period, and wherein enforcing the access restrictions comprises preventing access outside of the limited time period.

16. The computer-readable medium of claim 15, wherein the limited time period is tied to shipping of the paper version of the purchased book.

17. The method of claim 1, wherein the access restrictions allow the user to access a limited portion of the digital version of the purchased book from anywhere within the digital version of the purchased book.

18. The computer-readable medium of claim 15, wherein the access restrictions allow the user to access a limited portion of the digital version of the purchased book from anywhere within the digital version of the purchased book.
